(19) United States
(12) Patent Application Publication
(10) Pub. No.: US 2026/0360839 A1
(43) Pub. Date: Nov. 12, 2026

(54) Energy Storage System, Vehicle, Device for Charging Energy Storage Units, and Method for Operating Energy Storage Units

(71) Applicant: Bayerische Motoren Werke Aktiengesellschaft, Munchen (DE)

(72) Inventor: Dirk HOHMANN, Hebertshausen (DE)

(21) Appl. No.: 19/489,814

(22) PCT Filed: Jun. 20, 2024
(86) PCT No.: PCT/EP2024/067241

§ 371 Date: Dec. 3, 2025

(30) Foreign Application Priority Data
Jul. 6, 2023 (DE) 10 2023 117 795.8

(51) Int. Cl. H01M 10/42; B60L 50/64; H01M 10/46

(52) U.S. Cl. CPC H01M 10/425; B60L 50/64; H01M 10/46; H01M 2010/4271; H01M 2220/20

(57) ABSTRACT

An energy storage system comprising multiple energy storage units and a control system having multiple first connection elements, wherein the energy storage units each have second connection elements which are or can be connected to the first connection elements, and wherein the energy storage units are designed in such a way that a different design and/or connection layout of the first connection elements can be recognized.

### BACKGROUND AND SUMMARY

The present disclosure relates to an energy storage system, to a vehicle, to a device for charging energy storage units, and to a method for operating energy storage units.

Energy storage systems of the type addressed are employed, for example, as traction batteries in electrically powered (motor) vehicles. For the operation and monitoring of the individual energy storage units that an energy storage system of this type comprises, the “master-slave” principle is frequently employed. In this case, for example the “master battery” assumes the monitoring and control of the remaining energy storage units and is responsible for communication with components of the respective vehicle. In this connection, U.S. Pat. No. 9,431,684 B2 proposes the employment of energy storage units which are capable of the self-assignment of a specific identifier (ID). By reference to this ID, it can then be determined which energy storage unit is the master unit. However, an approach of this type appears to be relatively complex, as all energy storage units must also be capable of delivering a logic function of this type.

An object of the present disclosure is therefore the specification of an energy storage system, of a vehicle, of a device for charging energy storage units, and of a method for operating energy storage units which enable the identification of different energy storage units in an efficient manner and with a low degree of complexity.

This object is achieved by a control system, by a vehicle, by a device, and by a method according to the present disclosure. Further advantages and features emerge from the description and from the attached figures.

According to the present disclosure, an energy storage system comprises a multiplicity of energy storage units and a control system having a multiplicity of first connection elements, wherein the energy storage units each have second connection elements which are or can be connected to the first connection elements, and wherein the energy storage units are designed such that a different configuration and/or connection layout of the first connection elements can be detected, in particular can be detected and processed. In particular, it can advantageously be detected that at least one first connection element has a different connection layout, for example carries a specific or predefined voltage value, and/or that, in one of the energy storage units, a switch or the like is actuated via a correspondingly configured first connection element. In consequence, the energy storage unit which is correspondingly “activated” in this manner can assume a specific property or assume a specific state, such as a specific operating mode, or the like. The above-mentioned control system can also be referred to as a battery management system (BMS), or can be part of a battery management system. According to one embodiment, the control system is provided by a control device. As further described hereinafter, a control system of this type, for example, can be a constituent of vehicle electronics or else of an apparatus for charging energy storage units, such as, for example, a corresponding charging device. The term “charging device” does not only signify external charging devices, by which energy storage units can be charged externally to a vehicle. The charging device can also be a charging device which is integrated in the vehicle, in particular permanently, in other words an onboard charging device.

The control system comprises the first connection elements, which can be configured as plugs or sockets. The second connection elements are configured in a complementary manner hereto. The control system and the first connection elements are connected by electrical conductors, such as a cable harness. The control system can be part of an onboard electrical system of a vehicle. The first connection elements are employed for the electrical contacting or contact-connection of the various energy storage units. Each of the first connection elements preferably comprises multiple first contact elements, which can be configured in the form of pins, bolts, studs, tabs, eyes, etc. The second connection elements comprise second contact elements, which are configured in a complementary manner thereto. By the usually metallic first and second contact elements, the actual electrical contacting and the transmission of signals, voltages/currents, measured values, etc. to and from the energy storage units is executed. The major advantage is provided in that, by the different configuration and/or connection layout of the first connection elements or of at least one first connection element, which difference can be detected by the energy storage units or by the energy storage unit, a distinction of the connected energy storage unit(s) is enabled. This is executed, for example, by the allocation of a specific property, or by the activation thereof. In particular, this provides the advantage that the energy storage units themselves can all be identically configured. According to one embodiment, the different configuration is executed by a different connection layout, in particular different electrical connection layout, of the first connection elements and/or by the provision of at least one mechanical actuator on at least one first connection element. Appropriately, by the different configuration and the detection thereof by the energy storage unit, a specific item of information can be transmitted to the respective energy storage unit, or a specific property, which is previously maintained in reserve in the energy storage units, can be activated.

Appropriately, different IDs (identifiers) are allocatable to the energy storage units by way of the different configuration and/or connection layout. In particular, a state or a property of the energy storage unit(s) can be activated by way of the different configuration. Advantageously, the configuration or connection layout of at least one first connection element can be employed for allocating a specific property to at least one energy storage unit. According to one embodiment, all first connection elements comprise the same number of contact elements. One of the contact elements can be provided to realize the different connection layout. Alternatively, one first connection element comprises at least one contact element which is not present in the remaining first connection elements, or vice versa. The above-mentioned contact element can also be referred to as a “communications interface” or can assume the function of a communications interface.

According to one embodiment, the control system is based on a master-slave architecture, and wherein the master property is allocatable to one energy storage unit by the connection layout and/or configuration of the first connection elements or of at least one first connection element. Correspondingly, the remaining energy storage units correspondingly operate as slaves.

According to one embodiment, at least one first connection element comprises a mechanical and/or electrical actuator. The energy storage units preferably comprise elements which are designed to cooperate with the mechanical and/or electrical actuator. An electrical actuator can be, for example, one of the above-mentioned first contact elements, which has a predefined voltage value which can be detected by the connected energy storage unit. A mechanical actuator can be a particular structural feature, such as a coding pin or the like, which actuates a switch or a light barrier on the connected energy storage unit, cf. the above-mentioned cooperation elements. The cooperation elements are provided, for example, in the second connection elements but, additionally or alternatively, can also be provided by control modules which are located in the energy storage units.

According to one embodiment, the energy storage units comprise control modules. By the control modules, in particular the different connection layout of the first connection elements can be detected. The control modules are appropriately designed to measure voltages and/or currents which are transmitted via the first connection elements and, appropriately, to execute the processing thereof (cf. the 0V/10V example below). According to one embodiment, the control modules are provided by processors, in particular microprocessors.

The energy storage units, in particular the control modules, are preferably designed, according to the configuration or connection layout, to deliver different operating properties. The energy storage units are preferably designed to deliver multiple operating modes or states. By the configuration or connection layout of the first connection elements, the latter can be individually activated and/or selected.

According to one embodiment, the control modules, according to the measured value or measured values captured, can employ different identifiers at the communications interface with the control system, or with a connected charging device.

According to one embodiment, at least one first connection element carries a different current and/or voltage value from the other first connection elements. According to one embodiment, the control system is designed such that the different connection layout is executed by at least one contact element of a first connection element, which to this end has a current or voltage value which is not present on the remaining first connection elements.

According to one embodiment, for example, a first contact element which is connected to a first energy storage unit is switched to a voltage of 0 volts, whereas the same first contact element in another first connection element, which is connected to a second energy storage unit, is switched to a voltage of 10 volts. The control modules, such as for example the microprocessors, in the energy storage units measure the voltage value and, according to the measured value, the software employs different identifiers at the communications interface with the charging device and/or with the vehicle control devices. According to one embodiment, the first connection elements respectively comprise one or at least one first contact element, which assumes or can assume a predefined voltage value or a voltage value which differs from that on the respective first contact elements of the other first connection elements.

It should be mentioned at this point that the energy storage units can be electrical energy stores, for example what are known as energy storage modules, which in turn preferably each consist of a multiplicity of individual energy storage elements or cells. In particular, the energy storage units are rechargeable energy stores or accumulators. These are preferably “traction batteries”, i.e. energy stores which are designed to supply power to the electric drive unit, such as, for example, the electric motor, of the respective vehicle. According to one embodiment, the control system is or can be connected to a multiplicity of energy storage units, wherein the energy storage units respectively comprise a control module, which is designed to execute the detection and processing of the different connection layout and/or configuration.

Vehicles of the type addressed, in particular, are land vehicles, preferably (fully) electrically powered land vehicles in particular. Land vehicles can be motor vehicles, such as passenger vehicles, utility vehicles or motorcycles (single-track or multi-track), also called tilting vehicles. However, vehicles can also be bicycles having an electric drive. Expressly, the above-mentioned overview is not to be understood as definitive.

Correspondingly, the present disclosure also addresses a vehicle, such as, for example, a motor vehicle, for example a motorcycle, wherein the vehicle comprises a multiplicity of arrangement regions for the multiplicity of energy storage units, and wherein one first connection element is respectively assigned to the arrangement regions, in particular in a stationary manner. In the event that the respective first connection elements are permanently or stationarily allocated to the arrangement regions, a spatial allocation for the respective arrangement region can be established. It is thus possible, for example, for the master property or a specific ID to be automatically assigned to an energy storage unit which is arranged on a specific arrangement region, which in consequence enables an identification and distinction of the connected energy storage units.

Alternatively, however, it is also possible that the connection elements are “freely” assignable to the various arrangement regions.

The arrangement regions are regions or sections in the motor vehicle which are designed and configured to accommodate the energy storage units. Appropriately, the energy storage units are individually removable. Appropriately, it is possible for the vehicle to be operated with a differing number of energy storage units. In other words, it is thus not necessary for all the arrangement regions to be occupied for the vehicle to function.

The present disclosure also addresses a device for charging energy storage units, wherein the device comprises at least one energy storage system according to the present disclosure. A device of this type for charging energy storage units is, for example, a charging device, wherein the charging device can be a portable or mobile charging device, which is provided to charge the energy storage units in or outside of the respective vehicle. Alternatively, the charging device can also be a stationary device, such as, for example, what is known as a wallbox or the like. By way of a further alternative, the charging device can be permanently installed in the vehicle.

The present disclosure moreover addresses a method for operating energy storage units, comprising the steps:
provision of a control system, which comprises first connection elements;
provision of a multiplicity of energy storage units, which comprise second connection elements for contacting the first connection elements;
a different configuration or connection layout of at least one of the first connection elements for the allocation or activation of a property of the energy storage unit which is contacted therewith or connected thereto.

The major advantage is that the energy storage units per se can all be embodied in an equivalent or identical manner, which, inter alia, reduces the variety of variants, and thus reduces costs. An external distinction is enabled by the first connection elements which, to this end, are not configured in an equivalent or identical manner and/or are not operated in an equivalent or identical manner. A first contact element of the first connection element which is connected to an energy storage unit “1” for example is switched to a voltage of 0 volts, whereas the same first contact element of another first connection element which is connected to an energy storage unit “2” is switched to a voltage of 10 volts. A microprocessor in the energy storage units measures the voltage value and the software which is provided, according to the measured value, employs different identifiers at the communications interface with the charging device and/or with the vehicle control devices, etc. Appropriately, the energy storage unit thus behaves in a different manner according to the connection layout and/or configuration of the first connection element or of the first connection elements, or of the respective contact elements. Thus, advantageously, the energy storage units per se can be embodied in an identical manner.

Appropriately, for the purposes of the differential connection layout, at least one first contact element of the corresponding first connection element is energized with a predefined voltage value or a mechanical actuator is provided on a first connection element, which is designed to cooperate in an appropriate manner with a second connection element which is configured in an analogous manner thereto.

In other respects, features and advantages mentioned in conjunction with the energy storage system apply correspondingly to the method, and vice versa.

Further advantages and features emerge from the following descriptions of one embodiment of a control system with reference to the attached figures.

### BRIEF DESCRIPTION OF THE DRAWINGS

FIG. 1 shows a schematic view of one embodiment of an energy storage system according to the present disclosure;

FIG. 2 shows the section A-A, as illustrated in FIG. 1.

### DETAILED DESCRIPTION OF THE DRAWINGS

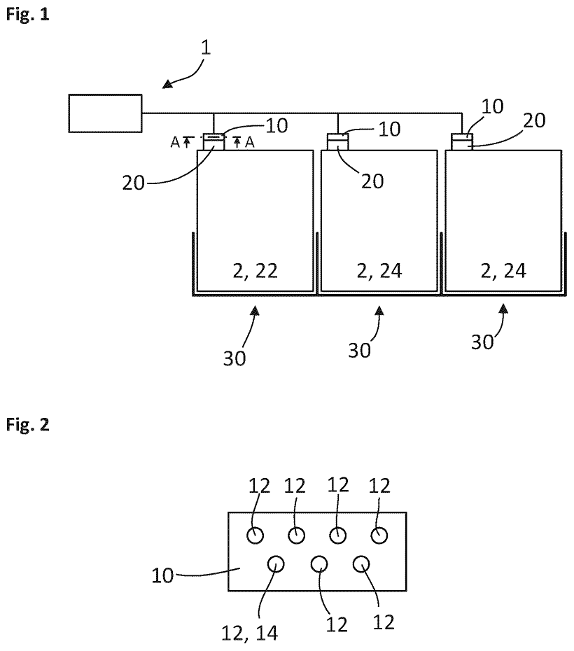

FIG. 1 shows a schematic view of one embodiment of an energy storage system, comprising a control system 1 having a plurality of, in the present case three, first connection elements 10. The first connection elements 10 are electrically connected to second connection elements 20 of three energy storage units or battery modules 2. In the present case, the connection elements 10 have a different circuit layout, such that one of the energy storage units 2, in the present case the left-hand unit, functions as the master 22. Correspondingly, the other energy storage units 2 operate as slaves 24. A first contact element of the first connection element 10, to the far left, is exemplarily switched to a voltage of 0 volts, whereas the analogous first contact element of the respective first connection elements 10, which are connected to the other energy storage units 2, is switched to a voltage of 10 volts. The energy storage units 2 can measure the voltage value, wherein, to this end, for example, a corresponding control module is provided therein. The energy storage units 2 behave differently according to the connection layout of the connection elements 10 but, advantageously, are all configured in an identical manner. Appropriately, by way of the connection layout, an identification of the energy storage units 2 can thus be executed. The energy storage units 2 are arranged in correspondingly configured arrangement regions 30. The arrangement regions 30 can be configured for example in a vehicle, such as, for example, a motor vehicle or else a bicycle. The section A-A is shown in an enlarged representation in FIG. 2.

FIG. 2 shows the section A-A illustrated in FIG. 1. The various first contact elements 12 of the left-hand first connection element 10 can be seen. It is illustrated that, for example, a first contact element 12 is employed for the realization of the different connection layout, cf. reference number 14.

This contact element 14 for example has a voltage which differs from that on the other connection elements. Alternatively, for example, it is also possible that this first contact element is entirely absent from the other first connection elements, or vice versa.

### LIST OF REFERENCE NUMBERS

1 Control system
2 Energy storage unit, battery module
10 First connection element
12 First contact element
14 First contact element
20 Second connection element
22 Master
24 Slave
30 Arrangement region

1-11. (canceled)

12. An energy storage system, comprising:
a plurality of energy storage units; and
a control system comprising a plurality of first connection elements,
wherein the plurality of energy storage units each comprise second connection elements which are configured to be connected to the first connection elements, and
wherein the plurality of energy storage units are configured such that a different configuration and/or connection layout of the first connection elements can be detected.

13. The energy storage system according to claim 12,
wherein different identifiers (IDs) are allocatable to the plurality of energy storage units via the different configuration and/or connection layout.

14. The energy storage system according to claim 12,
wherein the control system is based on a master-slave architecture, and
wherein a master property is allocatable by the configuration and/or connection layout of the first connection elements.

15. The energy storage system according to claim 12,
wherein at least one first connection element comprises a mechanical and/or electrical actuator.

16. The energy storage system according to claim 15,
wherein the plurality of energy storage units comprise cooperation elements configured to cooperate with the mechanical and/or electrical actuator.

17. The energy storage system according to claim 12,
wherein the plurality of energy storage units comprise control modules, and
wherein the control modules are configured to deliver different operating properties.

18. The energy storage system according to claim 12,
wherein at least one first connection element carries a different current or voltage value from the other first connection elements.

19. A motor vehicle comprising:
the energy storage system according to claim 12.

20. The vehicle according to claim 19,
wherein the vehicle comprises a plurality of arrangement regions for the plurality of energy storage units, and
wherein one first connection element is respectively assigned to the arrangement regions in a stationary manner.

21. A device for charging energy storage units,
wherein the device is connected to the energy storage system according to claim 12.

22. A method for operating energy storage units, comprising:
providing a control system comprising first connection elements;
providing a plurality of energy storage units, which comprise second connection elements configured to contact the first connection elements; and
providing a different configuration or connection layout of at least one of the first connection elements for allocation or activation of a property of a respective energy storage unit that is contacted therewith.
